(19) United States
(12) Patent Application Publication
(10) Pub. No.: US 2012/0178322 A1
(43) Pub. Date: Jul. 12, 2012

(54) COATED FABRIC AND RELATED METHODS THEREFOR

(76) Inventors: Naresh R. Mehta, Cranston, RI (US); David A. Pettey, Westport, MA (US); Jeffrey C. Flath, Warwick, RI (US)

(21) Appl. No.: 13/264,458

(22) PCT Filed: Mar. 26, 2010
(86) PCT No.: PCT/US10/28840

§ 371 Date: Mar. 27, 2012

Related U.S. Application Data
(60) Provisional application No. 61/169,646, filed on Apr. 15, 2009.

(51) Int. Cl. B32B 5/02; B32B 27/32; C08J 11/10; B32B 27/06; B32B 37/14; C08J 11/04; B32B 27/36; B32B 5/26

(52) U.S. Cl. 442/65; 442/164; 428/221; 442/170; 442/171; 156/60; 521/40; 521/47; 521/48; 521/41; 521/46.5

(57) ABSTRACT

A coated fabric with a first fabric layer having a first surface and a second surface, wherein the first fabric layer is comprised of a first polymer, and a first coating layer that is disposed on at least a portion of the first surface of the first fabric layer, wherein the first coating layer is comprised of the first polymer is disclosed. Fabricating the coated fabric can comprise providing a fabric, and applying or bonding at least a portion of a polymeric layer onto at least a portion of a first surface. The coated fabrics can advantageously serve as a protective barrier against natural elements with a long service life. One of more coated fabrics can act as a barrier to prevent seepage of water into the ground and/or serve as a surface for printing and decoration. The present coated fabrics can also be tailored to specific applications.

### BACKGROUND

1. Field

The present disclosure relates to coated fabrics, and more particularly to fully recyclable fabrics coated with at least one polymeric layer.

2. Discussion of Related Art

Fabrics can be coated with a polymeric material. Because the material of the fabric and the polymeric material are not typically compositionally the same or similar, recycling of laminates or coated fabrics involves separation of the dissimilar materials before recycling or recovery operations.

### SUMMARY OF THE DISCLOSURE

One or more aspects of the disclosure relates to a coated fabric comprising at least one reinforcement layer comprised of a recyclable material, and at least one polymeric layer disposed on a first side of the at least one reinforcement layer; the polymeric layer comprised of the recyclable material. The at least one reinforcement layer can comprise a woven fabric.

One or more aspects pertain to a coated fabric, comprising a first fabric layer having a first surface and a second surface, the first fabric layer comprised of a first polymer, and a first coating layer disposed on at least a portion of the first surface of the first fabric layer, the first coating layer comprised of the first polymer. The coated fabric can further comprise a second coating layer disposed on at least a portion of the second surface of the first fabric layer, wherein the second coating layer is comprised of the first polymer. The coated fabric can also further comprise a third coating layer disposed on at least a portion of a surface of the first coating layer. The coated fabric can, in still other cases, further comprise a fourth coating layer that is disposed on at least a portion of a surface of one of the first coating layer, the second coating layer and the third coating layer. The first fabric layer can comprise a random arrangement of non-woven fibers but in other configurations can comprise a woven fabric. The coated fabric can further comprise a second fabric layer disposed adjacent to one of the first fabric layer and the first coating layer. The coated fabric first polymer can comprise, consist essentially of, or consist of a thermoplastic polymer selected from the group consisting of polyethylene terephthalate, high density polyethylene, low density polyethylene, polypropylene, polystyrene, and nylon.

One or more aspects pertain to a method of fabricating a coated fabric. The method can comprise providing a fabric layer comprised of a first polymer; the fabric layer typically having a first surface and a second surface, and bonding a first polymeric layer comprised of the first polymer on at least a portion of the first surface of the fabric layer. In the method of fabricating the coated fabric, the first polymer can comprise, can consist essentially of, or can consist of a polyolefin. Thus, in some cases, the first polymer is a polyolefin. The polyolefin can comprise, consist essentially of, consist of, or is a poly-α-olefin. The method of fabricating the coated fabric can further comprise bonding a second polymeric layer comprised of, consists essentially of, or consists of a polyolefinic material on at least a portion of the second surface of the fabric layer. The method of fabricating the coated fabric can further comprise recycling the fabric layer with the first polymeric layer. The method of fabricating the coated fabric can further comprise melting the fabric layer together with the first polymeric layer.

One or more aspects pertain to a method of recovering a fabric having at least one coating layer. The method of recovering the fabric can comprise melting the fabric comprised of a thermoplastic polymer with the at least one coating layer, wherein the at least one coating layer is comprised of or consists essentially of a thermoplastic material. The fabric and the at least one coating layer can be comprised of, consist essentially of, or consist of the same thermoplastic polymer selected from the group consisting of high density polyethylene, low density polyethylene, polypropylene, polyethylene terephthalate, polystyrene, and nylon. In the method of recovering the fabric, an initial melting temperature of the thermoplastic polymer of the fabric is typically not greater than or is within 15° C. of an initial melting temperature of the thermoplastic material of the at least one coating. In other cases, the initial melting temperature of the thermoplastic polymer of the fabric is not less than or within 15° C. of an initial melting temperature of the thermoplastic material of the at least one coating.

In some embodiments in accordance with some aspects of the invention, the fabric and the at least one coating layer does not comprise a halogenated thermoplastic polymer. In some embodiments in accordance with some aspects of the invention, the fabric and the at least one coating is comprised of polyvinyl chloride.

### BRIEF DESCRIPTION OF THE DRAWING

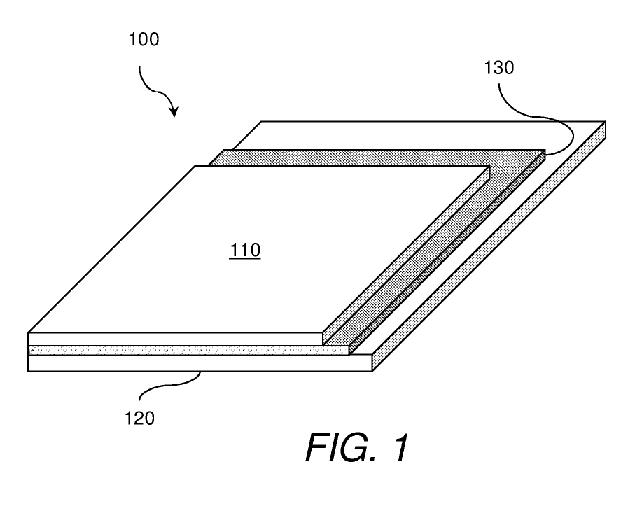

The accompanying drawing is not intended to be drawn to scale. For purposes of clarity, not every component may be labeled in every drawing. FIG. 1 is a schematic representation of an embodiment showing an exploded view of a coated fabric or a laminate with two polymeric layers and a reinforcing or reinforcement layer, in accordance with some aspects of the disclosure.

### DETAILED DESCRIPTION

The disclosed features and aspects herein are not limited to the details of construction and the arrangement of components set forth in the following description or illustrated in the drawings. One or more aspects of the present disclosure is capable of other embodiments and of being practiced or of being carried out in ways other than in the manner explicitly described herein.

One or more aspects of the disclosure pertain to a coated fabric comprising, consisting of, or in some cases, consisting essentially of a first fabric layer having a first surface and a second surface, the first fabric layer comprised of a first polymer, and a first coating layer disposed on at least a portion of the first surface of the first fabric layer, the first coating layer comprised of the first polymer. One or more aspects of the disclosure relates to a method of coating a fabric. The fabric with a first surface and a second surface can be coated with a first polymeric layer by bonding to the first surface of the fabric layer and bonding a second polymeric layer to the second surface of the fabric layer.

Other aspects of the disclosure relate to a method of fabricating a coated fabric or to coating a fabric with one or more polymeric layers. Any of the methods can comprise providing a fabric, and applying or bonding at least a portion of a polymeric layer onto at least a portion of a first surface.

The coated fabrics disclosed herein can advantageously serve as a protective barrier against natural elements with a long service life. For example, one of more coated fabrics disclosed herein can act as a barrier to prevent seepage of water into the ground and/or serve as a surface for printing and decoration. The present coated fabrics can be tailored to specific applications. The coated fabric can be prepared by encapsulating a fabric between two or more polymer coating layers.

The one or more fabric or substrate layers typically exhibits a chemical affinity to the polymer of the coating layer and will readily bond to it. Further, various configurations of the presently disclosed coated fabric can reduce or eliminate the need of a through-bond for adhesion between the coating and the fabric. Thus single-layer coated fabrics are contemplated.

FIG. 1 exemplarily illustrates an embodiment pertinent to one or more aspects disclosed herein. In the schematic illustration presented in FIG. 1, a coated fabric generally indicated at 100 can comprise a first polymeric layer 110 and, optionally, a second polymeric layer 120. In one embodiment, coated fabric 100 comprises at least one fabric layer 130 disposed proximate at least one of first and second layers 110, 120, and preferably, between the first and second layers. At least a portion of a surface of first polymeric layer 110 is typically directly in contact with at least a portion of a first surface of fabric layer 130. As shown, the contacting surfaces are preferably bonded or at least portions thereof are secured together. If a surface of second polymeric layer 120 is in contact with a surface of fabric layer 130, as shown, at least portions of each of the contacting surfaces are preferably bonded, or at least portions thereof are secured together.

In some embodiments of the invention, the coated fabric 100 can comprise a first fabric layer 130 disposed adjacent, and preferably bonded to a first coating layer 110, and optionally to a second coating layer 120. First coating layer 110 is typically disposed on at least a portion of a first surface of fabric layer 130. Second coating layer 120 is typically disposed on at least a portion of a second surface of fabric layer 130. Optional configurations can involve a third coating layer disposed on at least a portion of a surface of the first coating layer. Further configurations can involve a fourth coating layer disposed on at least a portion of a surface of one of the first coating layer, the second coating layer and the third coating layer. The first fabric layer can comprise, consist essentially of, or consist of a random arrangement of non-woven fibers but other configurations can involve configurations wherein the first fabric layer comprises, consists essentially of, or consists of a woven fabric.

Advantageous configurations of the invention can pertain to a first polymer that comprises a thermoplastic polymer selected from the group consisting of polyethylene terephthalate, high density polyethylene, low density polyethylene, polypropylene, polystyrene, and nylon. In some cases, at least a portion of any of the first polymer and the second polymer can comprise the same thermoplastic polymeric material. In some cases, the first polymer and the second polymer consists of the same thermoplastic polymeric material. Preferred embodiments typically involve the same thermoplastic polymeric material such that a substantial portion of the thermoplastic material matrix of the fabric, the first coating, and, when present, the second coating involve the same thermoplastic binder. The thermoplastic material can be based on, for example, an extrudable or moldable polymer. Advantageous embodiments can comprise compounded thermoplastic polymeric materials based on at least one polymeric matrix. The polymeric matrix, for example, can comprise, consist of, or consist essentially of any of polystyrene, polypropylene, polybutylene, polyethylene, poly(vinyl chloride), poly(vinyl fluoride), poly(vinylidene fluoride), polycarbonate, polyimide, polyamide, polyisoprene, styrene butadiene copolymer, polybutadiene, ethylene propylene copolymer, polyisobutylene, halogenated polyisobutylene such as chlorobutyl and bromobutyl variants, polyacrylate, polyacrylonitrile, polychloroprene, chlorosulfonated polyethylene, polyurethane, polysiloxane, polysulfide, polychlorotrifluoro ethylene, vinylidene fluoride, hexafluoropropylene, polyester polyether copolymer, styrenated aliphatic copolymer, ethylene acrylate copolymer or ethylene interpolymeric alloys and derivatives thereof such as those commercially available as ELVALOY® from E.I du Pont de Nemours and Company, Wilmington, Del., and blends or mixtures thereof.

In other embodiments of the invention, the coated fabric can comprise, consist essentially of, or consist of a loft or a fiber layer of randomly arranged fibers. The fabric is typically a thermoplastic material that is polymerically similar if not identical to the polymeric composition of the first coating layer and the optional second coating layer. In some cases, the polymeric material of the first coating layer is classified or has the same resin identification code, as defined by the Society of the Plastics Industry (SPI), as the resin identification code of the material of the fabric layer. The optional second, third, and fourth coating layers typically also have the same resin identification code. As such, the coated fabric can thus have a singular resin identification code. Non-limiting examples of the thermoplastic matrix of one or more of the coated fiber can involve polyethylene terephthalate, high density polyethylene, low density polyethylene, polypropylene, polystyrene, and nylon.

In advantageous embodiments, any of the coating layers, or even the fabric layer can comprise a thermoplastic polymeric material comprising a polymeric matrix compounded to have desirable characteristics. For example, any of the polymeric coating layers, or at least a portion thereof, can be compounded with agents that provide weather resistance and, in some cases, flame or fire resistance. In still other advantageous embodiments, at least one polymeric layer or at least a portion thereof can comprise other agents that improve mechanical properties thereof such as, but not limited to, creep resistance, tear resistance, tensile strength, elasticity or strain, hardness, glass transition temperature and impact resistance. For example, the polymeric matrix of the polymeric layer can comprise at least one reinforcing agent such as but not limited to carbon black, silica, and blends or variant grades thereof. In yet other embodiments, any of the polymeric layers can comprise a material compounded with at least one pigment, at least one plasticizer or processing aid, and combinations thereof. In still other cases, the polymeric matrix can incorporate one or more components that modify the resultant density of the layer. For example, blowing agents or hollow beads can be incorporated into the polymeric matrix that decreases the specific gravity of the resultant polymeric layer. Still other additives that can be utilized include, but are not limited to those that modify the electrical properties of the polymeric layer. For example, conductive agents can be compounded into the polymeric matrix that increases the electrical conductivity thereof.

The amount or type or both of each or any of the compounding components of the polymeric layer can vary to provide any desirable characteristic. For example, a phthalate plasticizer can be compounded into a polyvinyl chloride-based polymeric layer in any amount ranging from about 1 part to 70 parts per 100 parts polymeric matrix. Likewise, titanium dioxide pigment can be utilized in any amount ranging from at least about 0.5 parts per 100 parts polymeric matrix. Other notable compounds or formulations may be utilized to tailor any of the chemical and mechanical properties of the polymeric layer.

As noted, first coating layer 110 can comprise the same type of compounded polymeric material as second coating layer 120 and fabric layer 130. In some embodiments, however, the membrane can advantageously utilize different compounded polymeric layers but each layer has similar melting ranges. For example, first polymeric layer can comprise a first polymeric material compounded to be weather resistance by incorporating therein one or more light stabilizing agents, anti-oxidant or anti-ozonant agents; and second polymeric layer can comprise a second polymeric matrix compounded to have a tear resistance greater than the first polymeric layer, but each of the layers can be comprised of a material of the same resin identification code, or can have the same melting temperature range, or at least have the same predominant polymeric matrix. As used, herein, the term predominant refers to a polymer of a composition that is at least about 50 wt %, but typically at least about 75 wt % of the total polymer content of the composition.

The amount of any of the antioxidants, antiozonants, light stabilizing agents, and process lubricants can be from about 0.1 parts to about 10 parts per 100 parts polymeric matrix.

First coating layer 110 and second polymeric layer 120 can be disposed on fabric layer 130 using any suitable technique. For example, any of the first and second layers can be disposed against at least a portion of the fabric layer by extrusion coating techniques. Other techniques that may be utilized include calendering any of the first and second layers on the loft layer. Likewise, where any further polymeric layers are utilized, any technique may be utilized to prepare a compound or multi-layered polymeric layer. Other techniques include, for example, air knife coating, immersion or dip coating, gap coating, curtain coating, rotary screen coating, reverse roll coating, gravure coating, metering rod (Meyer bar) coating, slot die (Extrusion) coating, hot melt coating, roller coating, and flexographic coating.

Particularly advantageous aspects of the present disclosure involve a coated fabric with a thickness in a range of from about 0.5 mil to 150 mil.

In some cases, fabric layer 130 can comprise a multi-layered arrangement including one or more randomly arranged matrix of fibers and one or more layers of reinforcing substrate. At least a portion of the substrate is typically secured or attached to the reinforcing substrate by suitable techniques, such as by melting together. The substrate can be needle-punched on or be adhesively secured thereto.

The at least one reinforcing layer or fabric layer can be a knit, woven, or cross-laid fabric.

The fabric layer is preferably a polyolefin and the at least one coating layer is also preferably a polyolefin. The fabric layer, in a preferred embodiment, has any of a 7 to 24 by 7 to 24 count of 50 to about 2,000 denier threads. A preferred configuration has a 9×9 count of about 1,000 denier threads. The first coating layer 110 is preferably extrusion coated with between 5 to 100 mils thick compounded thermoplastic polyolefin. In an optional second pass, an additional 5 to 100 mils thick compounded thermoplastic polyolefin can be coated onto the opposite side.

When forming the polymeric layers, stress relieving techniques may be utilized. For example, the composite single ply membrane may be annealed at temperatures approaching the melting point of the polymeric materials of the membrane. Thus, because the matrix materials of each of the fabric layer and the one or more coating layers can utilize similar if not the same thermoplastic material, stress-relaxing or relieving can be effected throughout the coated fabric.

The thermoplastic coating and fabric layer can be nip squeezed between rollers, typically heated rollers, to promote bonding of the thermoplastic layers. However, other techniques may be utilized to fabricate the coated fabric.

Furthermore, it is recognized that there may be many sources for suitable polymeric layers. While a method has been given for its production, the disclosed product and method does not turn on the exclusive utilization of any particular thermoplastic material.

The composition of the thermoplastic material may be weather resistant, mold resistant, fungi resistant, flame resistant (according to NFPA 701 vertical burn or ASTM E-108) and pass the requirements of the CSFM (California State Fire Marshall).

In a preferred embodiment, the thickness of the polymeric compound ranges from 5 mils to 100 mils. Where a plurality of coating layers are utilized, each of the coating layers can have differing thicknesses. In some exemplary cases, however, each of the coating layer is about 40% to about 45% of the overall thickness of the coated fabric.

In a preferred embodiment, the weight of the scrim or fabric ranges from 0.5 oz. to 20 oz. per square yard. Also, in a preferred embodiment, the range of polymers that can be used include olefins, PVC, TPO, EVA, EMA, EBA, Elvaloy ®, PVC/Elvaloy ®, PVC/Urethane, PVB, Polyamide, TPU, PVC/Nitrile, ABS, PVDF, PET, PBT, polycarbonate, acrylics and mixtures, copolymers, or blends thereof.

The coated fabric can be utilized as or as a component of any of roofing membranes, geomembranes for ground covering, billboards or billboard substrates, tents, and water tanks or bladders.

For example, roofing membranes can utilize coated fabrics, as disclosed herein, comprising polypropylene knit or woven fabric (10×12, 1,000 denier) that was fabricated by extrusion coating with polypropylene copolymers (TPO) having flame resistance and UV resistance properties. The polypropylene knit or woven fabric can be needle-punched with polypropylene fibers, extrusion coated on one side with a thermoplastic polyolefin to make a fleece-backed membrane. Such a membrane can be fully adhered to at least a portion of a roof and can be overlapped and be capable of being secured through heat seams. Thus, in some cases, the coated fabrics can be utilized in fabricating one or more laminates as disclosed in U.S. Pat. No. 7,169,719, which is incorporated herein for all purposes.

Geomembranes can utilize the various coated fabrics disclosed herein. For example, a thermoplastic polyolefin knit or woven fabric can be extrusion coated with the same or similar thermoplastic polyolefin, such as polypropylene. Preferred configurations can involve a needle-punched polypropylene knit or woven fabric. The fleece can thus provide resistance to puncture from sharp objects on the ground.

As a billboard component, a knit or woven fabric (such as 9×9, 500 denier) of polypropylene or polyethylene, or a blend thereof, can be extrusion coated with a printable polyethylene layer at a width of approximately 200 inches. Similarly, a nonwoven fabric of, for example, 30 gsm to 220 gsm, can be extrusion coated with a printable polypropylene or polyethylene compound.

As components of tents, a needle-punched polypropylene knit or woven fabric (such as 9×9, 2000 denier) can be extrusion coated with a thermoplastic polyolefin formulation colored to specific requirements. Lightweight tents for military application can involve polypropylene knit or woven fabric (9×9 1000 denier) can be extrusion coated with a flame resistant (FR) thermoplastic polyolefin (TPO) formulation, with camouflage colors in accordance with military specifications.

As components of water tanks and or fluid bladders, polyolefinic woven fabric (such as 24×24, 1000 denier) can be extrusion coated with one or more thick layers of TPO.

In some cases, the coated fabric can involve a polyethylene knit, woven, non-woven or composite fabric. In some cases, the coated fabric can involve a polypropylene substrate needle-punched with polypropylene fibers and coated with a polymer from the olefin family. The coated fabric is 100% recyclable as all its components are compatible with each other. Thus, some aspects involve recycling the coated fabric without separation of the fabric layer from the coating layer. In some cases, the material of the one or more fabric layers and the material of the one or more coating layers have the same melting ranges. In other cases, the initial melting temperature of the thermoplastic material of at least one coating layer is within less than 15° C., preferably within less than 10° C., and more preferably within less than 5° C. of a melting temperature range of the thermoplastic material of the fabric layer. The coated fabrics can thus be completely recyclable without separation of the various layers thereof beforehand. Notable aspects of the invention can therefore involve a method of recycling the coated fabric consisting of concurrently melting the fabric with its one or more layers, typically by heating the coated fabric to a melting temperature or a melting temperature range for a predetermine period which can less than one hour, less than 30 minutes, less than 15 minutes, or until the coated fabric becomes a melted homogeneous polymer.

The function and advantages of these and other embodiments of the present disclosure can be further understood from the examples below, which illustrate the benefits and/or advantages thereof but do not exemplify the full scope of the disclosure.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives.

Those skilled in the art should appreciate that the parameters and configurations described herein are exemplary and that actual parameters and/or configurations will depend on the specific application in which the systems and techniques of the disclosure are used. Those skilled in the art should also recognize or be able to ascertain, using no more than routine experimentation, equivalents to the specific embodiments of the disclosure. It is therefore to be understood that the embodiments described herein are presented by way of example only and that the disclosure may be practiced otherwise than as specifically described.

Moreover, it should also be appreciated that the disclosure is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the disclosure as embodied in the claims. Further, acts, elements, and features discussed only in connection with one embodiment are not intended to be excluded from a similar role in other embodiments.

As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A coated fabric, comprising:
a first fabric layer having a first surface and a second surface, the first fabric layer comprised of a first polymer; and
a first coating layer disposed on at least a portion of the first surface of the first fabric layer, the first coating layer comprised of the first polymer.

2. The coated fabric of claim 1, further comprising a second coating layer disposed on at least a portion of the second surface of the first fabric layer, the second coating layer comprised of the first polymer.

3. The coated fabric of claim 2, further comprising a third coating layer disposed on at least a portion of a surface of the first coating layer.

4. The coated fabric of claim 3, further comprising a fourth coating layer disposed on at least a portion of a surface of one of the first coating layer, the second coating layer and the third coating layer.

5. The coated fabric of any one of claims 1, wherein the first fabric layer comprises a random arrangement of non-woven fibers.

6. The coated fabric of any one of claims 1, wherein the first fabric layer comprises a woven fabric.

7. The coated fabric of any one of claims 1, further comprising a second fabric layer disposed adjacent one of the first fabric layer and the first coating layer.

8. The coated fabric of any one of claims 1, wherein the first polymer comprises a thermoplastic polymer selected from the group consisting of polyethylene terephthalate, high density polyethylene, low density polyethylene, polypropylene, polystyrene, and nylon.

9. A method of fabricating a coated fabric, comprising:
providing a fabric layer comprised of a first polymer, the fabric having a first surface and a second surface; and
bonding a first polymeric layer comprised of the first polymer on at least a portion of the first surface of the fabric layer.

10. The method of claim 9, wherein the first polymer is a polyolefin.

11. The method of claim 10, wherein the polyolefin is a poly-α-olefin.

12. The method of claim 10, further comprising bonding a second polymeric layer comprised of a polyolefinic material on at least a portion of the second surface of the fabric layer.

13. The method of any one of claims 9, further comprising recycling the fabric layer with the first polymeric layer.

14. The method of any one of claims 9, further comprising melting the fabric layer together with the first polymeric layer.

15. A method of recovering a fabric with at least one coating layer, the method comprising melting the fabric comprised of a thermoplastic polymer with the at least one coating layer, wherein the at least one coating layer is comprised of the a thermoplastic material.

16. The method of claim 15, wherein the fabric and the at least one coating layer is comprised of the same thermoplastic polymer selected from the group consisting of high density polyethylene, low density polyethylene, polypropylene, polyethylene terephthalate, polystyrene, and nylon.

17. The method of claim 15, wherein an initial melting temperature of the thermoplastic polymer of the fabric is not greater than 15° C. of an initial melting temperature of the thermoplastic material of the at least one coating.

18. The method of claim 15, wherein an initial melting temperature of the thermoplastic polymer of the fabric is not less than 15° C. of an initial melting temperature of the thermoplastic material of the at least one coating.

19. The method of any one of claims 15, wherein the fabric and the at least one coating layer does not comprise a halogenated thermoplastic polymer.

20. The method of claim 15, wherein the fabric and the at least one coating is comprised of polyvinyl chloride.
